(19) United States
(12) Patent Application Publication
(10) Pub. No.: US 2010/0131791 A1
(43) Pub. Date: May 27, 2010

(54) SIGNAL PROCESSING APPARATUS AND SIGNAL PROCESSING SYSTEM

(75) Inventor: Tomoo Kimura, Fukuoka (JP)

Correspondence Address: PEARNE & GORDON LLP, 1801 EAST 9TH STREET, SUITE 1200, CLEVELAND, OH, 44114-3108, US

(73) Assignee: PANASONIC CORPORATION, Osaka (JP)

(21) Appl. No.: 12/595,994

(22) PCT Filed: Apr. 16, 2008
(86) PCT No.: PCT/JP2008/001003

§ 371 Date: Oct. 15, 2009

(30) Foreign Application Priority Data
May 9, 2007 (JP) P2007-124721

(51) Int. Cl. G06F 1/28; G06F 1/08

(52) U.S. Cl. 713/340; 713/500

(57) ABSTRACT

A signal processing apparatus includes a signal processor a processing amount predictor for predicting a processing amount in the signal processor based on the signal data and outputting a processing amount prediction value, a processing amount observer for observing a processing amount of the signal processing executed by the signal processor and outputting a process completion value, and a control value decision section for deciding a voltage of the power and a frequency of the clock, which are supplied to the signal processor, based on the processing amount prediction value, the process completion value, and elapsed information indicating an elapsed time from a start of the signal processing. The power supplier supplies the power whose voltage is decided by the control value decision section to the signal processor, and the clock supplier supplies the clock whose frequency is decided by the control value decision section to the signal processor.

### TECHNICAL FIELD

The present invention relates to a signal processing apparatus and a signal processing system capable of assuring a real-time processing in response to a processing amount.

### BACKGROUND ART

As the low power consumption control that executes power control in response to a processing amount so as to reduce power consumption, the technology that executes the clock control in response to execution conditions of the task to be executed on OS (Operating System) is provided (see Patent Literature 1, for example). FIG. 11 is a timing chart showing power-saving control every task, which is set forth in Patent Literature 1. The timing chart shown in FIG. 11 indicates execution states of respective tasks, performance set states, and operation states of CPU.

Meanwhile, the technology that implements low power consumption by incorporating a control flag, which is used to supply/stop a voltage or a clock, into instruction codes of CPU is provided (see Patent Literature 2, for example). In the concerned technology, supply/stop of the clock is controlled in response to the instructions that are executed successively on a basis of the instruction code, i.e., the cycle of CPU. However, the power consumption control capable of assuring that completion of a processing should be attained within a predetermined time, while monitoring an overall processes amount by predicting or observing an amount of overall instructions or an amount of processed data is not applied.

Patent Literature 1: JP-A-8-76874

Patent Literature 2: JP-A-2002-169790

### DISCLOSURE OF THE INVENTION

### Problems that the Invention is to Solve

The above low power consumption control given by reference to Patent Literature 1 is the adaptive operation state control responding to a processing amount in unit of task that is managed by OS. However, the system performance is changed due to the external factor or the internal factor because a real-time management of the task is not performed, and the concerned control lacks the quick response because this control corresponds to the OS management method. Therefore, in the concerned control, it is not assured that completion of the executed task (processing) should be attained within a predetermined time.

In the above low power consumption control given by reference to Patent Literature 2, the control can be applied on a cycle basis in unit of instruction of CPU. However, the power consumption control capable of assuring that completion of the processing of an amount of overall instructions or an amount of processing data should be attained within a predetermined time cannot be executed.

It is an object of the present invention to provide a signal processing apparatus and a signal processing system capable of controlling both a processing capability and low power consumption, while assuring a real-time operation that attains completion of a designated processing within a predetermined time.

### Means for Solving the Problems

According to an aspect of the invention, there is provided a signal processing apparatus, including: a signal processor for signal-processing input signal data to output resultant data; a power supplier for supplying a power to the signal processor; a clock supplier for supplying a clock to the signal processor; a processing amount predictor for predicting a processing amount in the signal processor based on the signal data to output a processing amount prediction value; a processing amount observer for observing a processing amount of the signal processing executed by the signal processor to output a process completion value; and a control value decision section for deciding a voltage of the power to be supplied by the power supplier to the signal processor and a frequency of the clock to be supplied by the clock supplier to the signal processor, based on the processing amount prediction value output from the processing amount predictor, the process completion value output from the processing amount observer, and elapsed information indicating an elapsed time from a start of the signal processing of the signal processor, wherein the power supplier supplies the power whose voltage is decided by the control value decision section to the signal processor, and the clock supplier supplies the clock whose frequency is decided by the control value decision section to the signal processor.

According to another aspect of the invention, there is provided a signal processing apparatus, including: a signal processor for signal-processing input signal data to output resultant data; a power supplier for supplying a power to the signal processor; a clock supplier for supplying a clock to the signal processor; a processing amount observer for observing a processing amount of the signal processing executed by the signal processor to output a process completion value; and a control value decision section for deciding a voltage of the power to be supplied by the power supplier to the signal processor and a frequency of the clock to be supplied by the clock supplier to the signal processor, based on an input processing amount specified value, the process completion value output from the processing amount observer, and elapsed information indicating an elapsed time from a start of the signal processing of the signal processor, wherein the power supplier supplies the power whose voltage is decided by the control value decision section to the signal processor, and the clock supplier supplies the clock whose frequency is decided by the control value decision section to the signal processor.

According to another aspect of the invention, there is provided a signal processing system including the signal processing apparatus and a processing amount specifying device for outputting the processing amount specified value that is input into the signal processing apparatus.

### ADVANTAGES OF THE INVENTION

According to the signal processing apparatus and the signal processing system of the present invention, both the processing capability and the low power consumption can be controlled while assuring the real-time operation that attains completion of the specified processing within a predetermined time.

### BRIEF DESCRIPTION OF THE DRAWINGS

FIG. 1 is a block diagram showing a signal processing apparatus of a first embodiment of the present invention.

FIG. 2 shows (a) a remaining processing amount and (b) power consumption with respect to an elapsed time ‘t’ respectively when a process is executed smoothly at an even pace until a target elapsed time ‘ta’ after the process is started.

FIG. 3 shows (a) a remaining processing amount and (b) an example of power consumption (an example in which a high-speed processing is applied in the late stage) with respect to an elapsed time ‘t’ respectively when a process does not smoothly proceeds.

FIG. 4 shows (a) a remaining processing amount and (b) an example of power consumption (an example in which a high-speed processing is applied in the middle stage) with respect to an elapsed time ‘t’ respectively when a process does not smoothly proceeds.

FIG. 5 shows (a) a remaining processing amount and (b) an example of power consumption (an example in which a high-speed processing is applied in the early stage) with respect to an elapsed time ‘t’ respectively when a process does not smoothly proceeds.

FIG. 6 is a block diagram showing a signal processing apparatus of a second embodiment of the present invention.

FIG. 7 is a block diagram showing a signal generating device that outputs signal data and a process-amount specified valued, which are to be input into the signal processing apparatus.

FIG. 8 is a block diagram showing a signal processing apparatus of a third embodiment of the present invention.

FIG. 9 shows a system constructed by a broadcasting station and a mobile terminal.

FIG. 10 is a block diagram showing a mobile terminal equipped with the signal processing apparatus of the third embodiment.

FIG. 11 is a timing chart showing power-saving control every task, which is set forth in Patent Literature 1.

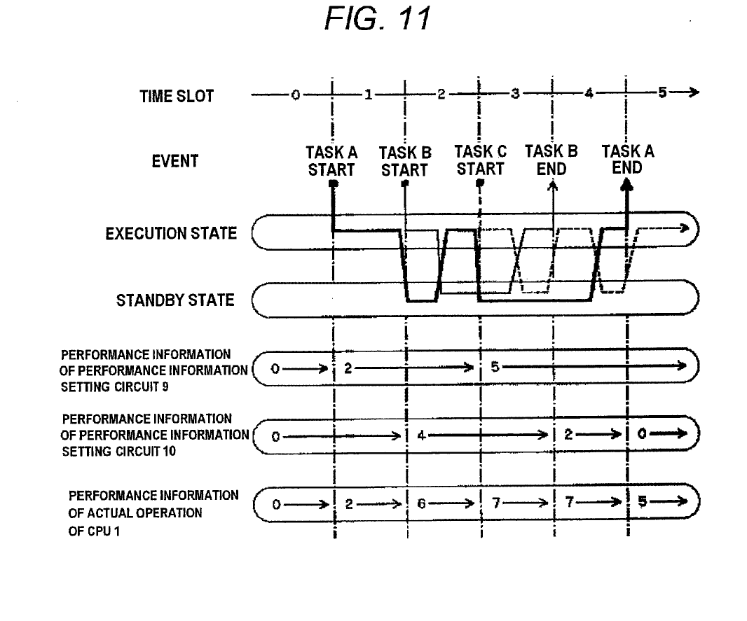

### DESCRIPTION OF REFERENCE NUMERALS

100 signal processor
101 processing amount predictor
103 processing amount observer
105, 205, 305 processing amount decision section
106 timer

### BEST MODE FOR CARRYING OUT THE INVENTION

Embodiments of the present invention will be explained with reference to the drawings hereinafter.

### First Embodiment

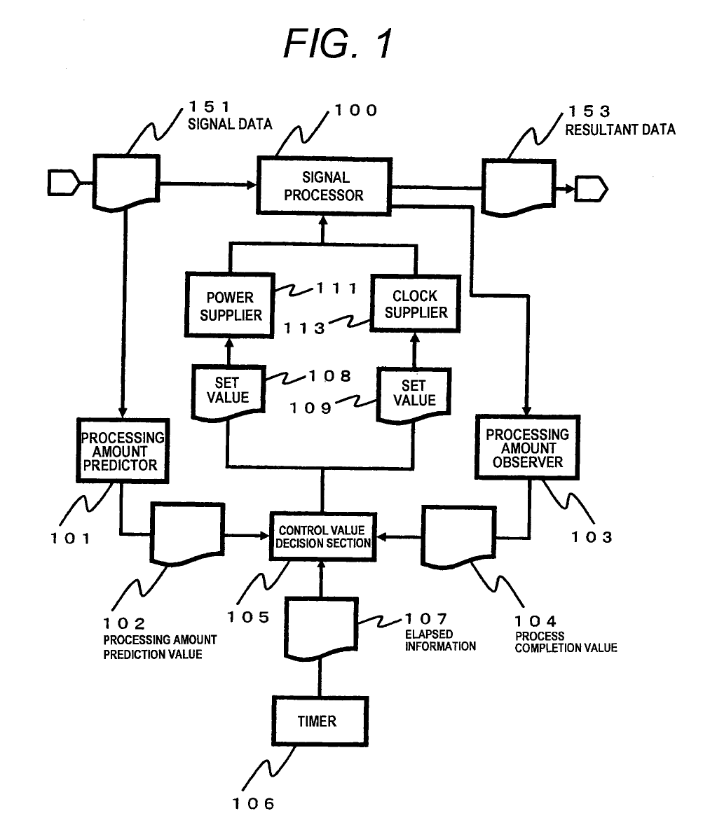

FIG. 1 is a block diagram showing a signal processing apparatus of a first embodiment of the present invention. As shown in FIG. 1, the signal processing apparatus of the first embodiment includes a signal processor 100, a processing amount predictor 101, a processing amount observer 103, a control value decision section 105, a timer 106, a power supplier 111, and a clock supplier 113.

The signal processor 100 signal-processes signal data 151 input from an external device, and outputs resultant data 153. A power supply is supplied from the power supplier 111 to the signal processor 100, and a clock is supplied from the clock supplier 113 to the signal processor 100. In the signal processor 100, a processing capability and power consumption in the signal processing are changed in response to a voltage of the power supply supplied from the power supplier 111 and a frequency of the clock supplied from the clock supplier 113.

The processing amount predictor 101 predicts a processing amount in the signal processor 100 based on the input signal data 151, and then outputs a processing amount prediction value 102. The processing amount observer 103 observes a processing amount of the signal processing that the signal processor 100 has executed, and then outputs a process completion value 104. The timer 106 counts an elapsed time from a start of the processing by the signal processor 100, and then outputs elapsed information 107 indicating the counted elapsed time.

The control value decision section 105 decides a voltage of the power supply that is supplied by the power supplier 111 to the signal processor 100, based on the processing amount prediction value 102, the process completion value 104, and the elapsed information 107, and then outputs a set value 108 indicating the decided voltage. Similarly, the control value decision section 105 decides a frequency of the clock that is supplied by the clock supplier 113 to the signal processor 100, based on the processing amount prediction value 102, the process completion value 104, and the elapsed information 107, and then outputs a set value 109 indicating the decided clock frequency. In this case, the power consumption in the signal processor 100 is increased much more as the power supply voltage becomes larger and the clock frequency becomes higher.

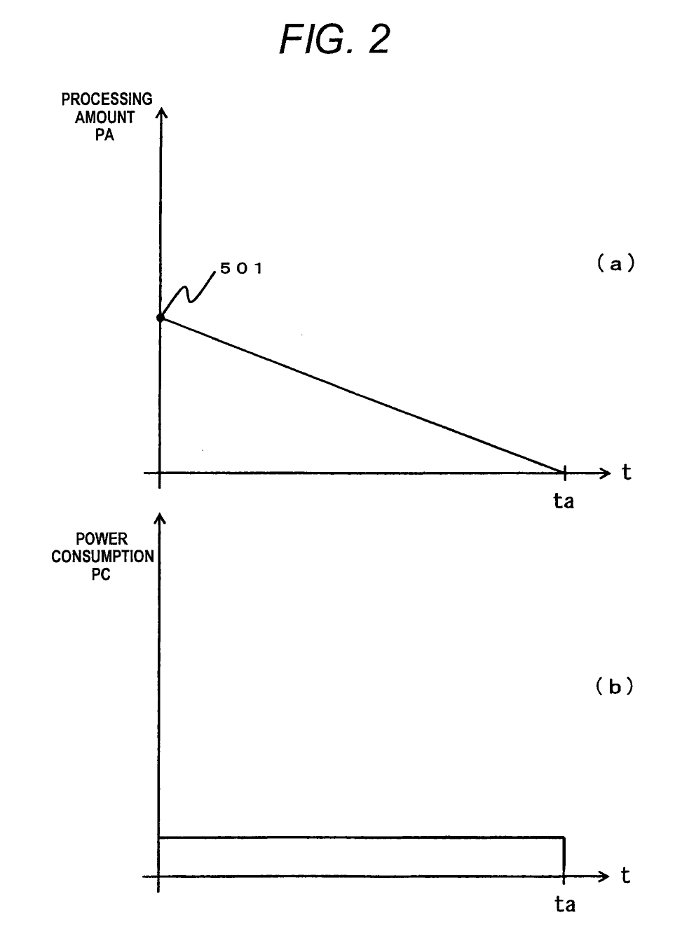

Examples 1 to 4 of the control that the signal processing apparatus of the present embodiment executes will be explained with reference to FIG. 2 to FIG. 5 hereunder. FIG. 2 to FIG. 5 show changes of (a) a remaining processing amount PA in the signal processor 100 and (b) power consumption PC in the signal processor 100 with respect to an elapsed time ‘t’ respectively. Here, a reference symbol ‘ta’ affixed to an abscissa in FIG. 2 to FIG. 5 denotes a target elapsed time that is used to assure the real-time processing.

### Example 1

Example 1 will be explained with reference to FIG. 2 hereunder. A reference numeral 501 affixed to an abscissa in FIG. 2(a) denotes a processing amount of the process to be executed. FIG. 2 shows (a) a remaining processing amount and (b) power consumption with respect to an elapsed time ‘t’ respectively when the process is executed smoothly at an even pace until a target elapsed time ‘ta’ after the process is started. As shown in FIG. 2, when the process is executed smoothly at an even pace, a throughput of the signal processor 100 is not changed. Therefore, the remaining processing amount is reduced smoothly and the power consumption is constant. As a result, in this case, it is possible to say that the process is completed with a minimum of power consumption until the target elapsed time ‘ta’.

### Example 2

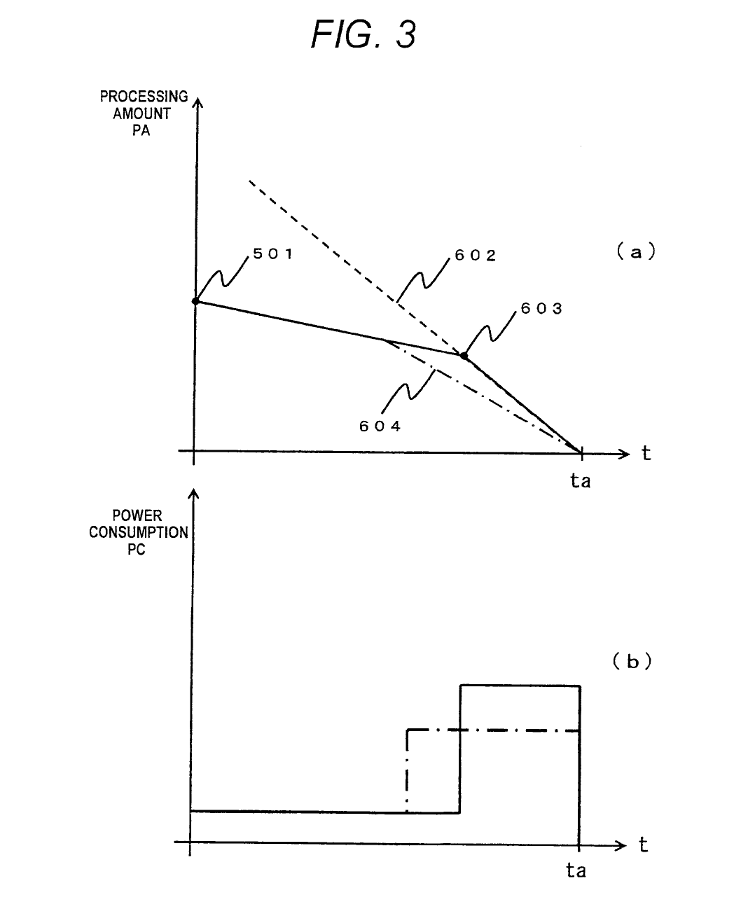

Example 2 will be explained with reference to FIG. 3 hereunder. FIG. 2 shows the case where the process smoothly proceeds, but the case where the process does not proceed as scheduled may be considered. As the factors causing such a situation that the process does not proceed smoothly, there are complication of the processed data, relations between the signal processing apparatus of the present embodiment and other means, e.g., a guarantee of standby of a shared memory, etc., and the like. FIG. 3 shows (a) a remaining processing amount and (b) an example of power consumption (an example in which a high-speed processing is applied in the late stage) with respect to an elapsed time ‘t’ respectively when a process does not smoothly proceed.

As shown in (a) of FIG. 3, in the present embodiment, when such a situation is predicted that the process does not proceed smoothly and the process is not completed by a target elapsed time ‘ta’, the control value decision section 105 enhances a processing capability of the signal processor 100 by increasing at least any one of a power supply voltage and a clock frequency, based on a process completed amount derived from the process completion value 104, a remaining processing amount estimated from the processing amount prediction value 102 and the process completion value 104, and an elapsed time indicated by the elapsed information 107.

A straight line indicated by a reference numeral 602 in (a) of FIG. 3 shows a predictive processing amount when the signal processor 100 executes the signal processing at a maximum performance. In an example shown in (a) of FIG. 3, when the control value decision section 105 decides that a remaining process cannot be completed by a target elapsed time ‘ta’ unless the signal processing is executed at a maximum performance of the signal processor 100 (a point of time shown in (a) of FIG. 3), such control value decision section 105 changes the set values 108, 109 such that the processing performance of the signal processor 100 is maximized. As a result, the process can be completed by a target elapsed time ‘ta’, and thus a real-time operation can be assured. In this event, the control value decision section 105 calculates a remaining time until a target elapsed time ‘ta’ from an elapsed time that the elapsed information 107 indicates, and then determines that, when a value obtained by adding the process completion value 104 and the processing amount prediction value 102 produced in a remaining time is smaller than an overall processing amount of the signal data 151, the signal processor 100 cannot complete the remaining process by a target elapsed time ‘ta’.

In this case, while the signal processor 100 executes the signal processing at a maximum performance, a voltage becomes higher and a clock frequency becomes higher than the normal state. Therefore, the power consumption is increased larger than the normal processing. As a result, as indicated by a solid line in (b) of FIG. 3, the power consumption required when the control of the processing performance of the signal processor 100 is applied is increased at a point of time when the processing performance of the signal processor 100 is maximized.

In an example shown in (a) of FIG. 3, the performance of the signal processor 100 is maximized at a point of time indicated by a reference numeral 603. In this case, the control value decision section 105 may apply the control to increase the performance of the signal processor 100 at a point of time positioned prior to the point of time indicated by a reference numeral 603. A processing amount at this time is indicated by a dot-dash line indicated by the reference numeral 604. When such control is applied at a point of time positioned prior to the point of time indicated by the reference numeral 603, there is no need that the performance of the signal processor 100 should be increased up to a maximum. As a result, as indicated by a dot-dash line indicated in (b) of FIG. 3, an increase of the power consumption is made smaller than that produced when the performance of the signal processor 100 is increased up to a maximum.

### Example 3

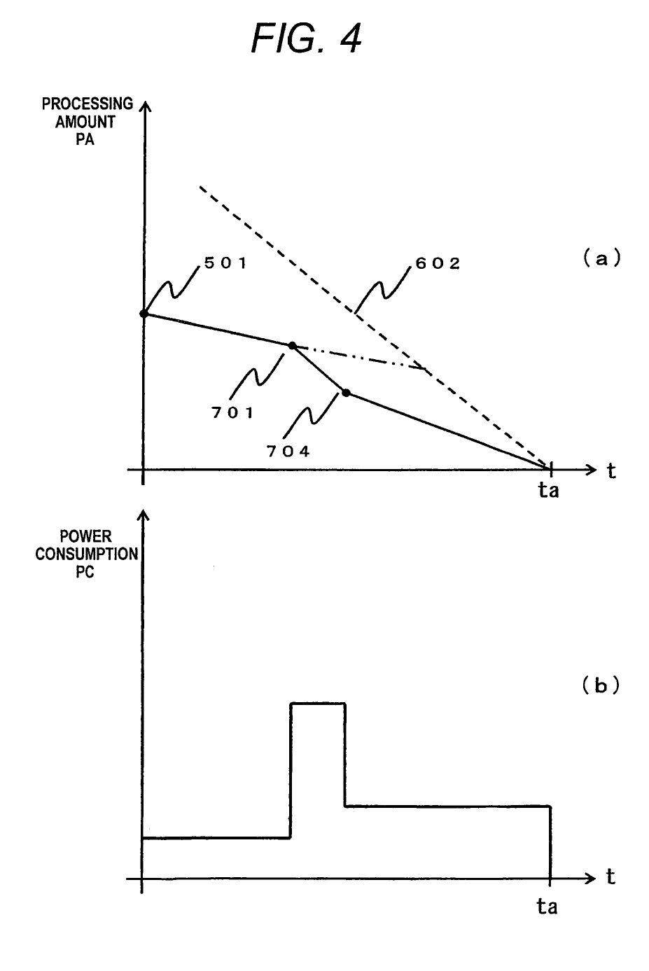

Example 3 will be explained with reference to FIG. 4 hereunder. FIG. 4 shows (a) a remaining processing amount and (b) an example of power consumption (an example in which a high-speed processing is applied in the middle stage) with respect to an elapsed time T respectively when a process does not smoothly proceeds. As shown in (a) of FIG. 4, in the present embodiment, when such a situation is predicted that the process does not proceed smoothly and the process does not complete by a target elapsed time ‘ta’, the control value decision section 105 predicts completion of the process based on the processing amount prediction value 101 at a point of time indicated by a reference numeral 701 shown in (a) of FIG. 4. In the present embodiment, when the control value decision section 105 determines that the signal processor 100 cannot complete a remaining process by a target elapsed time ‘ta’, the control value decision section 105 maximizes the processing performance of the signal processor 100 by increasing the power supply voltage and the clock frequency up to a maximum. Then, the control value decision section 105 decreases the power supply voltage and the clock frequency at a point of time indicated by a reference numeral 704 shown in (a) of FIG. 4 prior to a target elapsed time ‘ta’ such that the process should be completed by a target elapsed time ‘ta’, and causes the processing performance of the signal processor 100 to restore to the ordinary value.

In an example shown in (a) of FIG. 4, the processing performance of the signal processor 100 is kept at its maximum state in a period from a point of time indicated by the reference numeral 701 to a point of time indicated by the reference numeral 704. In this case, the processing performance may be increased higher than that being set up to a point of time indicated by the reference numeral 701. However, the processing performance of the signal processor 100 is set at a point of time indicated by the reference numeral 704 and after a point of time indicated by the reference numeral 704 such that the process should be completed by a target elapsed time ‘ta’. Also, when the control value decision section 105 determines that the process cannot be completed by a target elapsed time ‘ta’, the processing performance of the signal processor 100 may be increased once again even after a point of time indicated by the reference numeral 704.

### Example 4

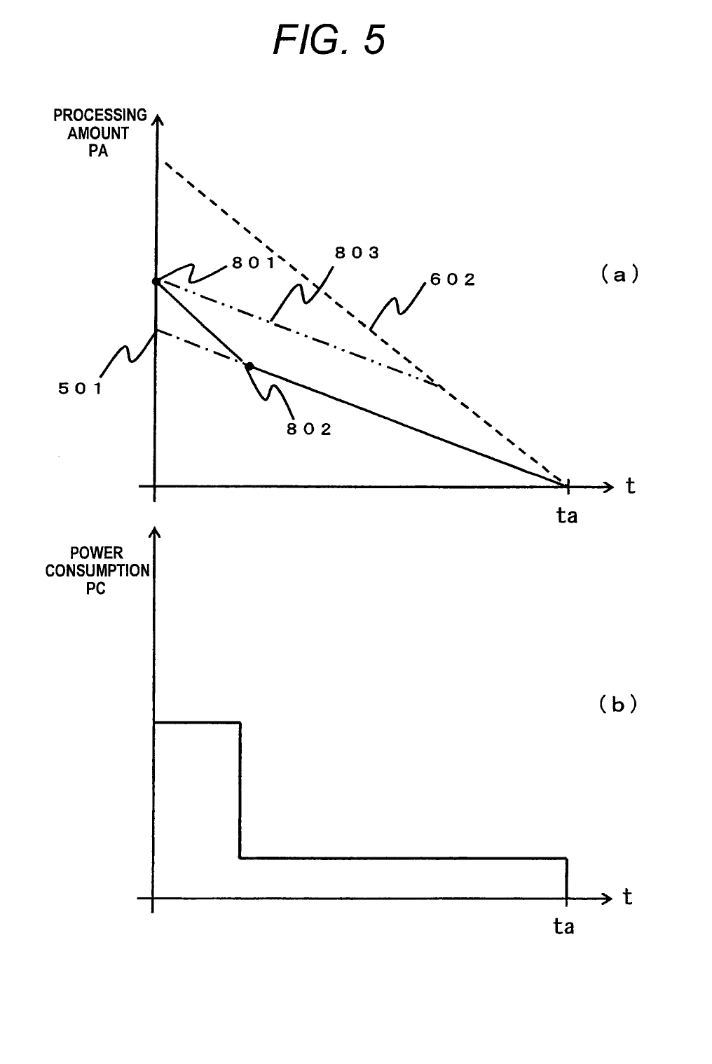

Finally, Example 4 will be explained with reference to FIG. 5 hereunder. FIG. 5 shows (a) a remaining processing amount and (b) an example of power consumption (an example in which a high-speed processing is applied in the early stage) with respect to an elapsed time ‘t’ respectively when a process does not smoothly proceeds. As shown in (a) of FIG. 5, in the present embodiment, when such a situation is predicted that the process does not complete by a target elapsed time ‘ta’ under the condition that a processing amount is massive and the signal processor 100 is set to the ordinary processing performance, the control value decision section 105 maximizes the processing performance of the signal processor 100 at a point of time of the process start indicated by a reference numeral 801, and the signal processor 100 starts the process. Then, the control value decision section 105 decreases the power supply voltage and the clock frequency at a point of time indicated by a reference numeral 802 shown in (a) FIG. 4 before a target elapsed time ‘ta’ such that the process should be completed by a target elapsed time ‘ta’, and causes the processing performance of the signal processor 100 to restore to the ordinary value.

As described above, according to the signal processing apparatus of the present embodiment, the processing capability of the signal processor 100 can be controlled by changing dynamically the power supply voltage and the clock frequency being supplied to the signal processor 100, in response to the estimated value of a processing amount and the processed situation. Therefore, the adequate low power consumption control can be applied while implementing the real-time processing in response to a processing amount.

### Second Embodiment

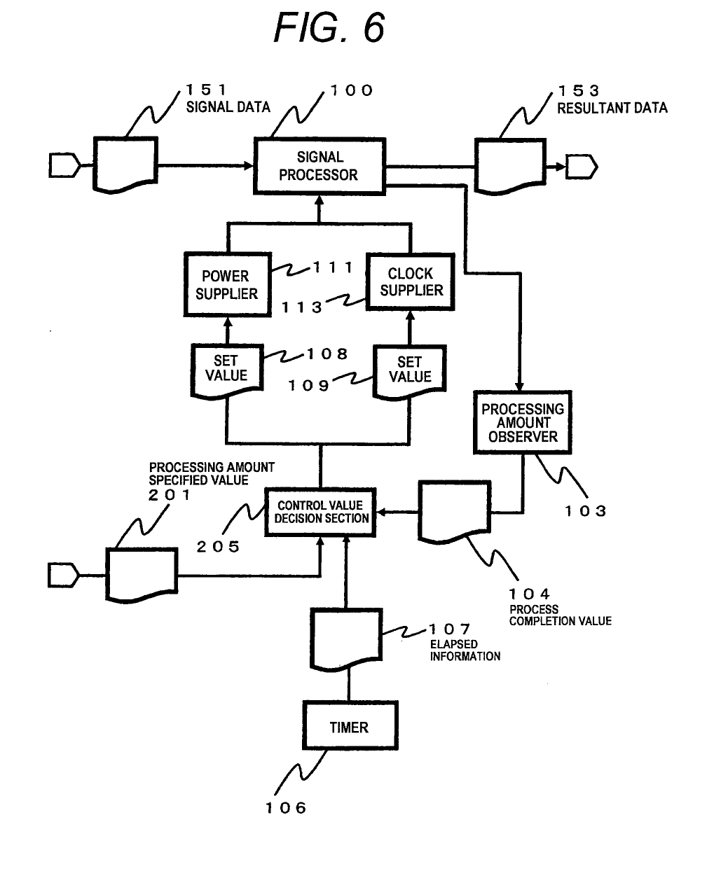

FIG. 6 is a block diagram showing a signal processing apparatus of a second embodiment of the present invention. A difference of the signal processing apparatus of the second embodiment from the signal processing apparatus of the first embodiment is that the processing amount predictor 101 is not provided and a control value decision section 205 is provided instead of the control value decision section 105. Remaining respects except this respect are similar to those in the first embodiment, and the same reference numerals are affixed to the constituent elements common to those in FIG. 1.

The control value decision section 205 decides the power supply voltage supplied by the power supplier 111 to the signal processor 100, based on a processing amount specified valued 201 being input from the external, the process completion value 104, and the elapsed information 107, and then outputs the set value 108 indicating the decided voltage. The processing amount specified valued 201 is the information that is input together with the signal data 151 being input from the external, and indicates a processing amount of the signal data 151.

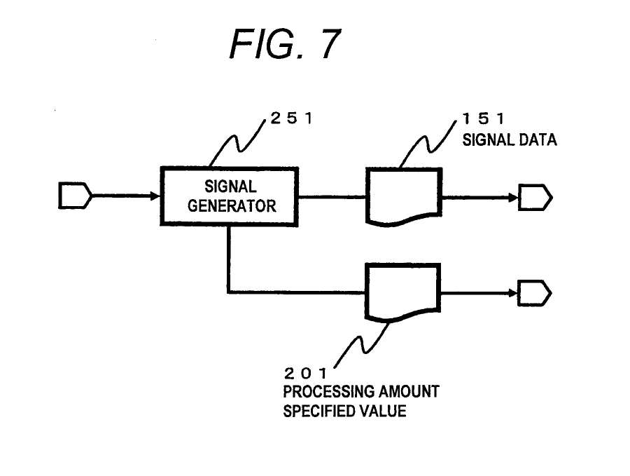

As shown in FIG. 7, the signal data 151 and the processing amount specified valued 201 are input from a signal generator 251 that is provided out of the signal processing apparatus of the present embodiment, for example. The signal generator 251 corresponds to a CD player, a DVD player, a memory card reader, a server for streaming-distributing data via a network, etc., for example. When the signal generator 251 corresponds to the CD player, the processing amount specified valued 201 indicates a data processing amount every piece of music. In this case, the processing amount specified valued 201 is recorded on the CD with respect to sound data of each piece of music respectively. The processing amount specified value 201 is attached to the data such as music data or moving image data, which needs a successive processing.

As described above, in the signal processing apparatus of the present embodiment, there is no need that the processing amount predictor 101 included in the signal generating device of the first embodiment should be provided. Therefore, a configuration can be simplified, and the power consumption can be reduced.

### Third Embodiment

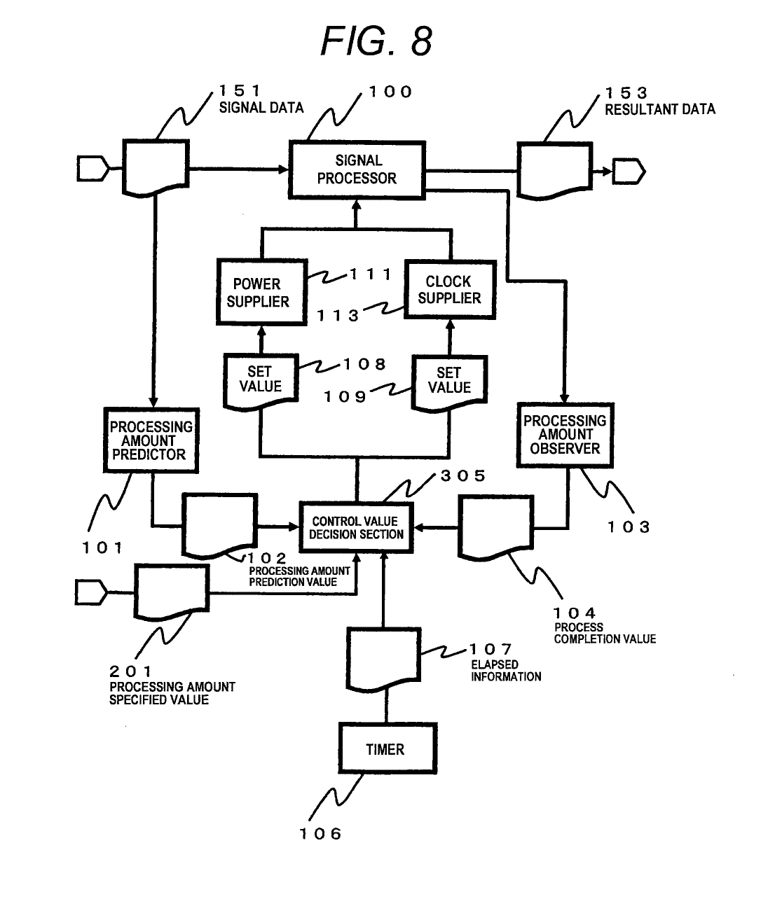

FIG. 8 is a block diagram showing a signal processing apparatus of a third embodiment of the present invention. A difference of the signal processing apparatus of the third embodiment from the signal processing apparatus of the first embodiment is that a control value decision section 305 is provided instead of the control value decision section 105. Remaining respects except this respect are similar to those in the first embodiment. In FIG. 6, the same reference numerals are affixed to the constituent elements common to those in FIG. 1.

The control value decision section 305 decides the power supply voltage supplied by the power supplier 111 to the signal processor 100, based on the processing amount prediction value 102, the processing amount specified valued 201 being input from the external, the process completion value 104, and the elapsed information 107, and then outputs the set value 108 indicating the decided voltage. The processing amount specified valued 201 has been explained in the second embodiment.

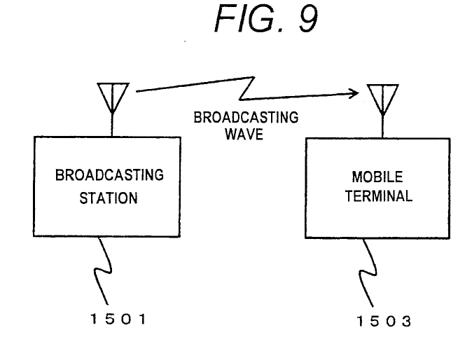

An application example of the signal processing apparatus in the above embodiments will be explained with reference to FIG. 9 hereunder. FIG. 9 shows a system constructed by a broadcasting station 501 and a mobile terminal 503. The broadcasting station 501 and the mobile terminal 503 holds the digital television broadcasting utilizing MPEG as the moving image coding-decoding system, or the like. The broadcasting station 501 includes the signal generator 251 shown in FIG. 7. The mobile terminal 503 corresponds to an electronic equipment having a function of receiving the digital television broadcasting, a cellular phone having the concerned function, or the like. The mobile terminal 503 includes the signal processing apparatus of the above embodiment in the interior.

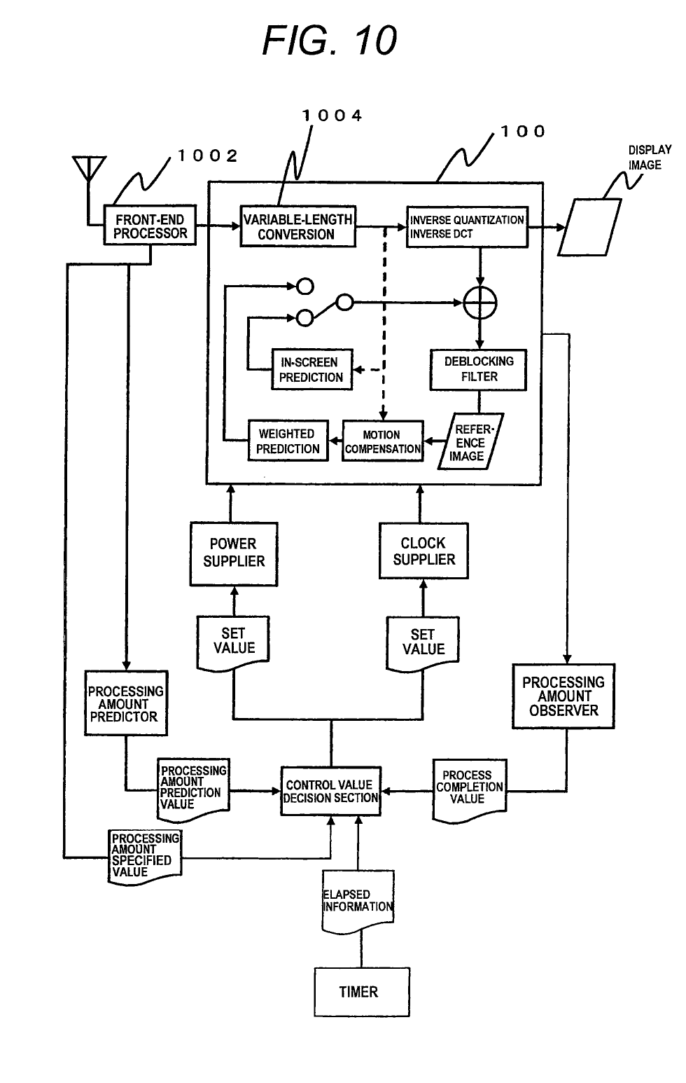

FIG. 10 is a block diagram showing the mobile terminal 503 including the signal processing apparatus of the third embodiment. As shown in FIG. 10, the mobile terminal includes the signal processing apparatus of the third embodiment, in addition to an antenna and a front-end processor 1002. In FIG. 10, an internal configuration of the signal processor 100 provided to the signal processing apparatus is explained as the MPEG decoder. In the mobile terminal 503 shown in FIG. 10, moving image data stream and the processing amount specified values 201 are extracted from the stream signal that is received by the front-end processor 1002, and then the moving image data stream is input into the signal processor 100 and also the processing amount specified valued 201 is input into the control value decision section 105.

Sometimes the broadcast wave cannot be correctly received depending on the surrounding environment of the mobile terminal 503, and the reception disturbance is caused. The particular error correcting process such as interpolation of the image, or the like is applied to the macro block (MB), in which the reception disturbance is caused, of the moving image. A following table shows the processing amount prediction value 102 every type (Not Codec, normal, error) of the macro block.

TABLE 1

| | Processing amount prediction |
|---|---|
| Type of MB | value 102 (Number of Cycles) |
| Not Codec | 100 |
| Normal | 500 |
| Error | 1000 |

In the above explanation, the processing amount prediction value 102 responding to the type of MB is obtained. In this case, the processing amount prediction value 102 may be output from a variable-length converter 1004 in the signal processor 100 shown in FIG. 10.

In the signal processing apparatus according to the above embodiments, the low power consumption control is applied dynamically even when a processing amount is increased/decreased irregularly. Therefore, this signal processing apparatus can achieve particularly an effect when the electronic device that is powered by the secondary battery and includes LSI should execute the application such as moving image and sound, graphics, game, or the like, which needs such a real-time processing that a specified amount of processing must be executed within a predetermined time.

The present invention is explained in detail with reference to the particular embodiments. But it is obvious for those skilled in the art that various variations and modifications can be applied without departing from a spirit and a scope of the present invention.

This application is based upon Japanese Patent Application (Patent Application No. 2007-124721) filed on May 9, 2007; the contents of which are incorporated herein by reference.

### INDUSTRIAL APPLICABILITY

The signal processing apparatus according to the present invention is useful to the signal processing apparatus that is capable of controlling both the processing capability and the low power consumption, while assuring the real-time operation that attains completion of the designated processing within a predetermined time.

1. A signal processing apparatus, comprising:
a signal processor for signal-processing input signal data to output resultant data;
a power supplier for supplying a power to the signal processor;
a clock supplier for supplying a clock to the signal processor;
a processing amount predictor for predicting a processing amount in the signal processor based on the signal data to output a processing amount prediction value;
a processing amount observer for observing a processing amount of the signal processing executed by the signal processor to output a process completion value; and
a control value decision section for deciding a voltage of the power to be supplied by the power supplier to the signal processor and a frequency of the clock to be supplied by the clock supplier to the signal processor, based on the processing amount prediction value output from the processing amount predictor, the process completion value output from the processing amount observer, and elapsed information indicating an elapsed time from a start of the signal processing of the signal processor,
wherein the power supplier is adapted to supply the power whose voltage is decided by the control value decision section to the signal processor, and the clock supplier is adapted to supply the clock whose frequency is decided by the control value decision section to the signal processor.

2. A signal processing apparatus, comprising:
a signal processor for signal-processing input signal data to output resultant data;
a power supplier for supplying a power to the signal processor;
a clock supplier for supplying a clock to the signal processor;
a processing amount observer for observing a processing amount of the signal processing executed by the signal processor to output a process completion value; and
a control value decision section for deciding a voltage of the power to be supplied by the power supplier to the signal processor and a frequency of the clock to be supplied by the clock supplier to the signal processor, based on an input processing amount specified value, the process completion value output from the processing amount observer, and elapsed information indicating an elapsed time from a start of the signal processing of the signal processor,
wherein the power supplier is adapted to supply the power whose voltage is decided by the control value decision section to the signal processor, and the clock supplier is adapted to supply the clock whose frequency is decided by the control value decision section to the signal processor.

3. The signal processing apparatus according to claim 1,
wherein the signal processor executes the signal processing in a mode, which is selected among a plurality of modes in which a throughput of the signal processing per unit time is different respectively, in response to the voltage of the power supplied from the power supplier and the frequency of the clock supplied from the clock supplier, and
wherein the control value decision section calculates from the elapsed information a remaining time required until a target elapsed time, at which completion of the signal processing of the input signal data in the signal processor is intended, and
determines that the signal processor cannot complete the signal processing by the target elapsed time when a value obtained by adding the process completion value and the processing amount prediction value in process to be executed in the remaining time is smaller than a total processing amount of the signal data at a predetermined timing, and controls the power supplier and the clock supplier such that the signal processor executes the signal processing in a second mode whose throughput per unit time is larger than a first mode that is selected in a normal state.

4. The signal processing apparatus according to claim 3,
wherein, when the control value decision section determines that the signal processor that is executing the signal processing in the second mode completes the signal processing by the target elapsed time, the control value decision section controls the power supplier and the clock supplier such that the signal processor executes the signal processing in a third mode whose throughput per unit time is smaller than the first mode or the second mode.

5. The signal processing apparatus according to claim 1, wherein the signal processor is adapted to decode the input signal data when the input signal data corresponds to data indicating a moving image, and
wherein the control value decision section is adapted to control the power supplier and the clock supplier in response to a type of a macro block or frame indicating the moving image.

6. The signal processing apparatus according to claim 1,
wherein the signal processor is adapted to execute a variable-length decoding of the input signal data when the input signal data corresponds to data that is compressed by a variable-length coding system, and
wherein the control value decision section is adapted to control the power supplier and the clock supplier in response to a varied amount of a data length.

7. A signal processing system, comprising:
the signal processing apparatus set forth in claim 2; and
a processing amount specifying device for outputting the processing amount specified value that is input into the signal processing apparatus.

8. The signal processing system according to claim 7,
wherein the processing amount specifying device is adapted to read a recording medium that stores the signal data and the processing amount specified value being input into the signal processing apparatus, and output the signal data and the processing amount specified value.

9. The signal processing apparatus according to claim 2,
wherein the signal processor executes the signal processing in a mode, which is selected among a plurality of modes in which a throughput of the signal processing per unit time is different respectively, in response to the voltage of the power supplied from the power supplier and the frequency of the clock supplied from the clock supplier, and
wherein the control value decision section calculates from the elapsed information a remaining time required until a target elapsed time, at which completion of the signal processing of the input signal data in the signal processor is intended, and
determines that the signal processor cannot complete the signal processing by the target elapsed time when a value obtained by adding the process completion value and the processing amount specified value in process to be executed in the remaining time is smaller than a total processing amount of the signal data at a predetermined timing, and controls the power supplier and the clock supplier such that the signal processor executes the signal processing in a second mode whose throughput per unit time is larger than a first mode that is selected in a normal state.

10. The signal processing apparatus according to claim 9,
wherein, when the control value decision section determines that the signal processor that is executing the signal processing in the second mode completes the signal processing by the target elapsed time, the control value decision section controls the power supplier and the clock supplier such that the signal processor executes the signal processing in a third mode whose throughput per unit time is smaller than the first mode or the second mode.

11. The signal processing apparatus according to claim 2,
wherein the signal processor is adapted to decode the input signal data when the input signal data corresponds to data indicating a moving image, and
wherein the control value decision section is adapted to control the power supplier and the clock supplier in response to a type of a macro block or frame indicating the moving image.

12. The signal processing apparatus according to claim 2,
wherein the signal processor is adapted to execute a variable-length decoding of the input signal data when the input signal data corresponds to data that is compressed by a variable-length coding system, and
wherein the control value decision section is adapted to control the power supplier and the clock supplier in response to a varied amount of a data length.
